(19) United States
(12) Patent Application Publication
(10) Pub. No.: US 2003/0007660 A1
(43) Pub. Date: Jan. 9, 2003

(54) Headphone device

(76) Inventors: Naotaka Tsunoda, Tokyo (JP); Koji Nageno, tokyo (JP)

Correspondence Address: Jay H. Maioli, Cooper & Dunham, 1185 Avenue of the Americas, New York, NY, 10036, US

(21) Appl. No.: 09/914,976

(22) PCT Filed: Dec. 28, 2000
(86) PCT No.: PCT/JP00/09426

(30) Foreign Application Priority Data
Jan. 7, 2000 (JP) 2000/5975
Jan. 7, 2000 (JP) 2000/5975

(51) Int. Cl. H04R 25/00; H04M 1/00

(52) U.S. Cl. 381/370; 381/371; 379/433.01

(57) ABSTRACT

A headphone device according to the present invention includes an earpad (5) to be worn from the outside of the ear (15) on the head (14), and a housing (4) that is provided with a speaker unit as well as a fitting portion (8) on which the earpad (5) is fit. The earpad (5) comprise a cushion (9) and a facing (10) that covers the cushion (9). The earpad (5) can be attached to and detached from the housing (4). By means of making it possible to detach the facing (10) from the cushion (9) as well, a headphone device can be obtained, in which the earpad can be kept clean and that have improved hygiene.

### TECHNICAL FIELD

The present invention relates to a headphone device. In particular, the present invention relates to a headphone device that includes a housing and an earpad fitted to the housing.

### BACKGROUND ART

In the following, an example of a conventional headphone device will be described referring to FIG. 1 and FIG. 2.

The headphone device a includes a pair of headphone bodies b,b and a headband c.

The headphone body b has a housing d in which a speaker unit (not shown in the figure) is disposed and a pliable earpad e fitted to the inner surface of the housing d.

The housing d is formed of an outer shell f having an approximate dome shape and a fitting portion g arranged on the peripheral edge of the opening of the outer shell f. A fitting groove h is formed extending circumferentially between the outer shell f and the fitting portion g.

The earpad e includes an approximate circular ring-shaped cushion i internally wrapped up in a facing j. The facing j is comprised of a cylindrical ring-shaped wrapping portion k that wraps up the cushion i and a fitted portion l that protrudes inward from the outer periphery of the internal wrapping portion k. The earpads e, e are fitted onto the housing d, d by inserting both of the fitted portions l, l into the fitting grooves h, h so as to cover the fitting portions g, g (see FIG. 2).

The headband c is curved upward forming a convex shape and has flexibility and elasticity. The headband c is provided as a spring member whose both ends are urged to approach each other. On both ends of the headband c hangers m, m are supported so that they can freely slide. These hangers m, m support the headphone bodies b, b allowing them to freely rotate on each on their end.

An auxiliary band n is provided between the hangers m, m.

The headphone device a is worn on the head o in such a manner that the earpads e, e of the headphone bodies b, b cover the ears p, p of the head o (see FIG. 1). On this occasion a fixed side pressure is transferred to the head o through the headphone bodies b, b by means of the elasticity of the headband c. In addition, the auxiliary band n is worn in such a state that it is in contact with the head o from above (see FIG. 1).

Meanwhile, because the headphone device is worn with the earpad of the headphone main body being in direct contact with the human body, it is preferable to keep the earpad clean when taking hygiene into consideration. The number of users who have such concern about hygiene has increased more and more in recent years.

In this type of conventional headphone device a, however, although the earpads e, e can be removed from the housing d, d, because the cushions i, i are wrapped with the facing j, j, the facings j, j cannot be removed from the cushions i, i.

Consequently, washing the facing j along with the cushion i is considered in order to keep clean the earpad e that is in direct contact with the human body of the person. However, the cushion i is normally formed of a urethane material with poor resistance to water. For this reason, unfavorable conditions occur when washing the facing j along with the cushion i. In reality, the only method available is to remove any dirt on the surface to wipe off the facing j using a rag and when taking hygiene into consideration, this never provides satisfactory cleaning.

Thereupon, the present invention aims to overcome the above-mentioned problems by providing a headphone device in which the earpad can be kept clean to improve hygiene.

### DISCLOSURE OF INVENTION

In order to solve the above-mentioned problem, the present invention provides a headphone device that includes an earpad to be worn from the outside of the ear on the head, and a housing that is provided with a speaker unit as well as a fitting portion on which the earpad is fit. The earpad is comprised of a cushion and a facing that covers the cushion. The earpad can also be attached to and detached from the housing and also the facing can be detached from the cushion.

Therefore, according to the headphone device of the present invention, the facing can be removed from the cushion.

### BRIEF DESCRIPTION OF DRAWINGS

FIG. 1 is a schematic front view of a conventional headphone device being worn on the head of a person. This figure has a cross section at one portion.

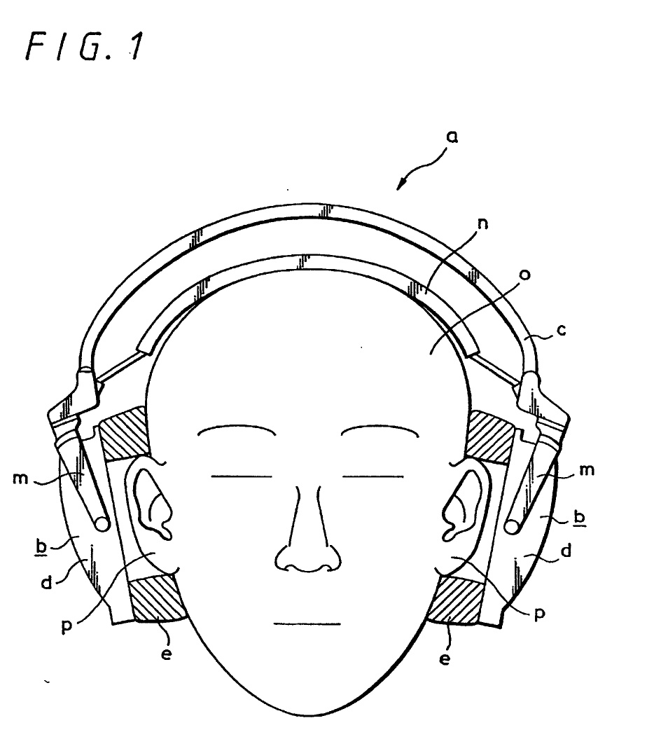

FIG. 2 is a schematic longitudinal sectional view of the headphone body of the headphone device shown in FIG. 1.

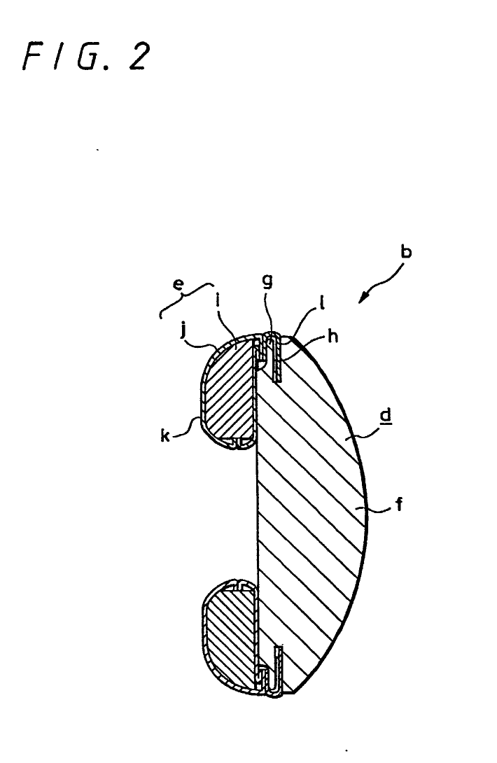

FIG. 3 is a schematic front view of the headphone device according to the present invention being worn on the head of a person. This figure has a cross section at one portion.

FIG. 4 is a schematic longitudinal sectional view of the headphone body of the headphone device shown in FIG. 3.

FIG. 5 is a schematic longitudinal sectional view of the earpad of the headphone device shown in FIG. 3.

FIG. 6 is a schematic longitudinal sectional view showing the earpad of FIG. 5 with the cushion and facing detached from each other.

FIG. 7 is a schematic longitudinal sectional view showing the earpad equipped with a cushion that does not have a hole.

FIG. 8 is a schematic longitudinal sectional view showing the earpad equipped with a cushion that has a hole.

### BEST MODE FOR CARRYING OUT THE INVENTION

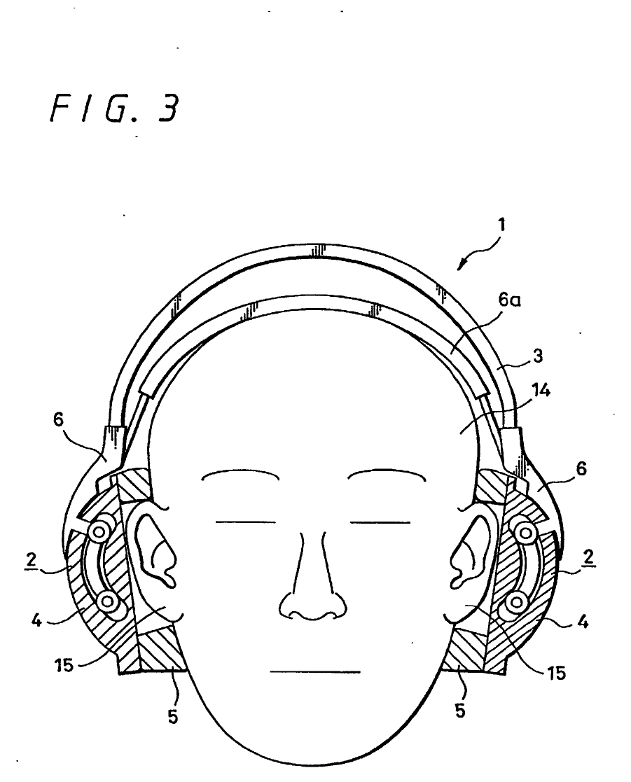

In the following, an embodiment of the headphone device according to the present invention will be described with reference to FIG. 3 through FIG. 8.

Referring to FIG. 3, the headphone device 1 is comprised of a pair of headphone bodies 2, 2 and a headband 3. The headphone bodies 2, 2 have a housing 4 and a pliable earpad 5 fitted to the inner surface of the housing 4, respectively.

The headband 3 is curved upward forming a convex shape and has flexibility and elasticity. Further, the headband 3 is provided as a spring member whose both ends are urged to approach each other. On both ends of the headband 3 hangers 6, 6 are supported so that they can freely slide. These hangers 6, 6 each support the headphone body 2 through a rotation mechanism (not shown in figure) allowing it to freely rotate.

An auxiliary band 6a is provided between the hangers 6, 6.

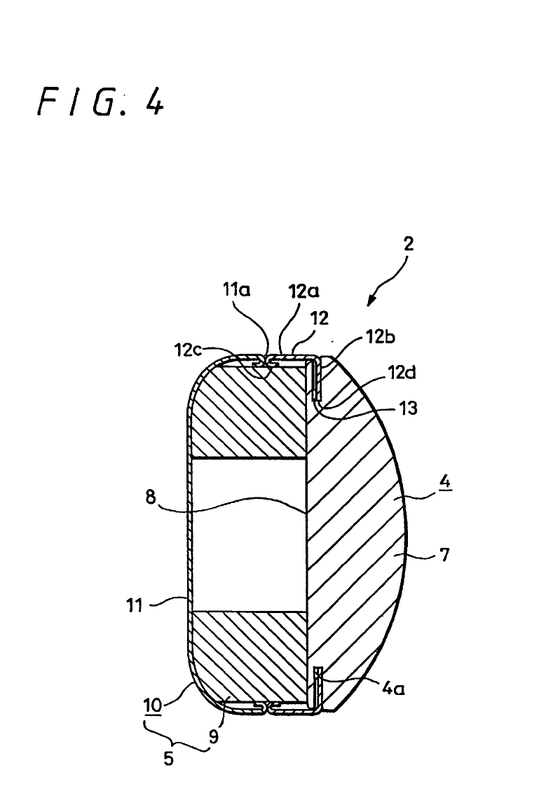

As shown in FIG. 4, the housing 4 is comprised of an outer shell 7 whose external shape forms an approximate dome shape and a disk-shaped fitting portion 8 arranged on one end side of the outer shell 7. A fitting groove 4a is formed extending circumferentially between the outer shell 7 and the fitting portion 8. A speaker unit (not shown in figure) is also disposed inside the housing 4.

As shown in FIG. 4 to FIG. 6, the earpad 5 is such that one portion of a pliable cushion 9 made of, for example, urethane, is covered by a facing 10 made of, for example, synthetic leather or a cloth material and fitted on the fitting portion 8 of the housing 4.

The cushion 9 has a circular shape slightly thick.

The facing 10 is comprised of a covering portion 11 and a fitted portion 12 seamed together. The external shape of the covering portion 11 is a round shallow container shape and its opening edge 11a is seamed to the fitted portion 12. The fitted portion 12 is formed of a ring-shaped peripheral surface portion 12a and a flange-shaped inserting portion 12b that protrudes from one end of the peripheral surface portion 12a towards the inside. The other end 12c of the peripheral surface portion 12a is seamed to the opening edge 11a of the covering portion 11. In addition, the opening on the inside of the inserting portion 12b is formed as an insertion/extraction opening 12d that functions for inserting and extracting the cushion 9 into and out of the facing 10.

A annular-shaped sheet 13 is bonded to the inner peripheral edge of the inserting portion 12b of the fitted portion 12. The sheet 13 is, for example, formed of a leather material that has a moderate hardness.

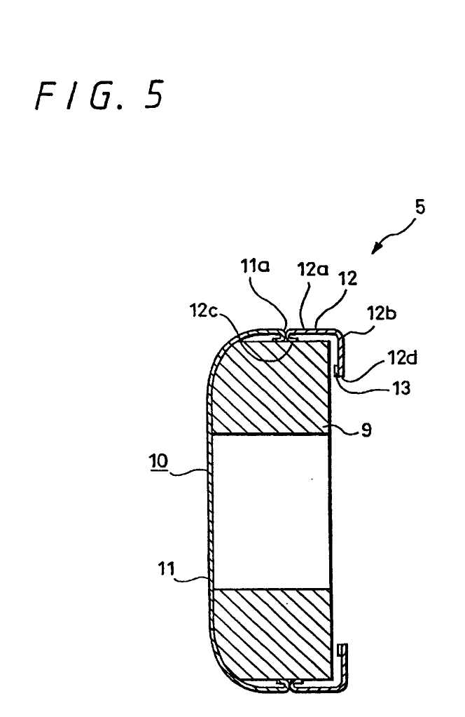

As shown in FIG. 4, the inserting portion 12b of the facing 10 is inserted to the inside of the fitting groove 4a of the housing 4 to attach the earpad 5 to the housing 4 in a state that the cushion 9 is inserted from the insertion/extraction opening 12d to the inside of the facing 10 as shown in FIG. 5. Because the sheet 13 is bonded on the inner peripheral edge of the inserting portion 12b and because of the sheet 13 itself, the thickness of the inner peripheral edge is increased to make the stiffness thereof enhanced, so that it is made easier to insert the inserting portion 12b into the fitting groove 4a.

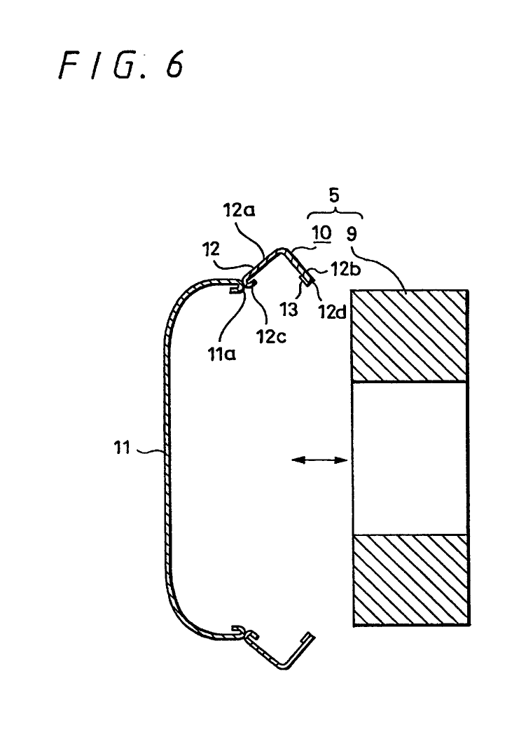

Further, the earpad 5 can be removed from the housing 4 by removing the inserting portion 12b from the fitting groove 4a. Then, as shown in FIG. 6, the cushion 9 and the facing 10 are detached by removing the cushion 9 from the insertion/extraction opening 12d.

As shown in FIG. 3, the headphone device 1 is worn on the head 14 in such a manner that the earpads 5, 5 of the headphone bodies 2, 2 cover the ears 15, 15 of a head 14. At this moment a fixed side pressure is transferred to the head 14 through the headphone bodies 2, 2 due to the elasticity of the headband 3. In addition, as shown in FIG. 3, the auxiliary band 6a is worn in a state that it is in contact with the head 14 from above.

As described above, in this headphone device 1, the earpads 5, 5 can be removed from the housings 4, 4 and the facings 10, 10 can be detached from the cushions 9, 9.

Consequently, because the facings 10, 10 can be detached from the cushions 9, 9 making it possible to wash only the facings 10, 10, the earpads 5, 5 can always be kept clean and have improved hygiene.

Moreover, because the external shape of the cushion 9 of the earpad 5 is round in this headphone device 1, no directional consideration is required when fitting the facing 10 onto the cushion 9 eliminating the need to adjust the positions of both. This makes it possible to improve the operability during fitting work.

In the example described above, although the external shape of the cushion 9 is formed to be round, the external shape of the cushion can be formed in any number of different shapes such as a polygon, an ellipse or the like which make it easy to adjust the positions during fitting work.

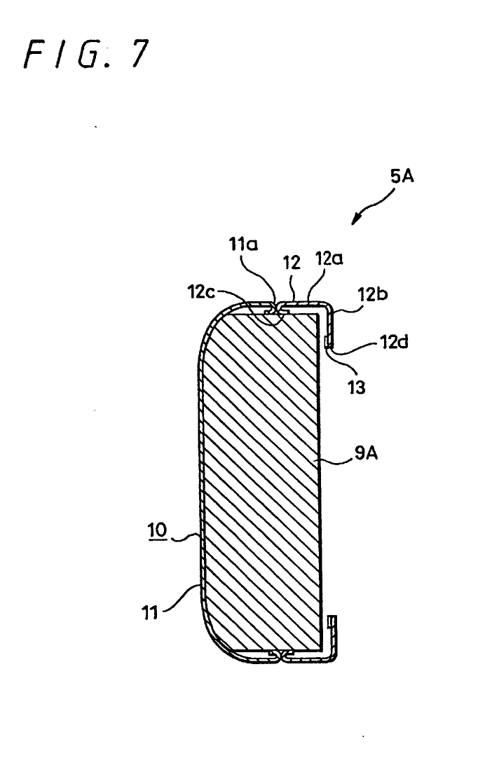

FIG. 7 shows an earpad 5A that uses a cushion 9A that does not have a hole formed at the center.

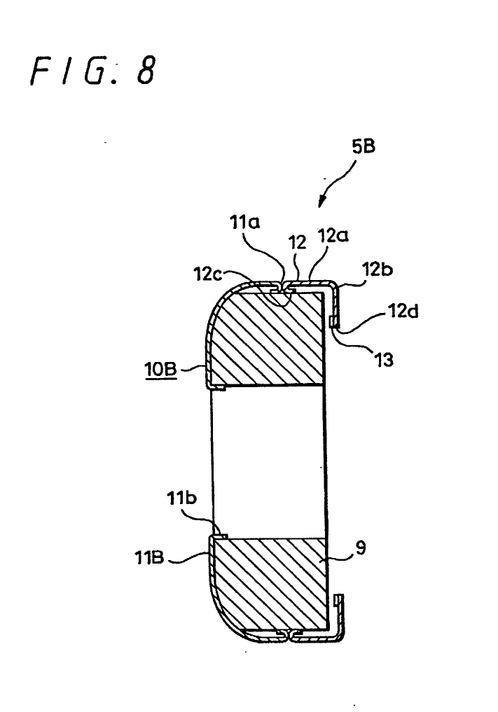

FIG. 8 shows an earpad 5B that uses a facing portion 10B that has a hole 11b formed at the center of the cover portion 11B in correspondence with the cushion 9.

In this manner, both earpads 5A, 5B shown in FIG. 7 or FIG. 8 are such that the facing 10 of the earpad 5A can be detached from the cushion 9A and in addition, the facing 10B of the earpad 5B can be detached from the cushion 9 as in the case of the earpad 5.

Therefore, the facing 10 or 10B are removed from the cushion 9A or 9 making it possible to wash only the facing 10 or 10B. Consequently, the earpad 5A or 5B can always be kept clean and have improved hygiene.

In addition, making it possible to detach the facing of the earpad from the cushion to improve the hygiene as described above is not limited to a headphone device but can also be applied to ear devices used for cold prevention or sound prevention as well.

The specific shapes and constructions of each part disclosed in the embodiment described above are only examples when implementing the present invention. They must not be interpreted as restricting the technical scope of the present invention.

As made clear by the description above, the headphone device according to the present invention comprises an earpad to be worn from the outside of the ear on the head, and a housing that is provided with a speaker unit as well as a fitting portion on which the earpad is fit. The earpad includes a cushion and a facing that covers the cushion. The earpad can also be attached to and detached from the housing and the facing can also be detached from the cushion.

Consequently, according to the headphone device of the present invention, because the facing can be removed from the cushion making it possible to wash only the facing, the earpad can always be kept clean and have improved hygiene.

Further, according to the headphone device of the present invention, because external shape of the cushion of the earpad is round, there are no directional considerations when fitting the facing onto the cushion eliminating the need to adjust the positions of both. This makes it possible to improve the operability during fitting work.

1. A headphone device comprising:
an earpad to be worn from the outside of the ear on the head and
a housing that is provided with a speaker unit as well as a fitting portion on which said earpad is fit, characterized in that
said earpad comprises a cushion and a facing that covers said cushion, and
said earpad can also be attache to and detached from said housing and also, said facing can also be detached from said cushion.

2. A headphone device as set forth in claim 1 characterized in that the external shape of said cushion of said earpad is formed in a circular shape.
